(19) United States
(12) Patent Application Publication
(10) Pub. No.: US 2026/0163723 A1
(43) Pub. Date: Jun. 11, 2026

(54) COMMUNICATION SYSTEM, COMMUNICATION APPARATUS, METHOD, AND PROGRAM

(71) Applicant: NTT, Inc., Tokyo (JP)

(72) Inventors: Sakae CHIKARA, Tokyo (JP); Tsunekazu SAITO, Tokyo (JP); Yutaro KIYOMURA, Tokyo (JP)

(21) Appl. No.: 19/123,565

(22) PCT Filed: Nov. 4, 2022
(86) PCT No.: PCT/JP2022/041176

§ 371 Date: Apr. 23, 2025

(51) Int. Cl. H04L 9/08; H04L 9/40

(52) U.S. Cl. CPC H04L 9/0838; H04L 63/0869

(57) ABSTRACT

A communication system according to one aspect of the present disclosure is a communication system including a plurality of communication apparatuses, in which the communication apparatuses each include a key generation unit configured to generate a shared key for performing encrypted communication with another communication apparatus of the plurality of communication apparatuses by using one or more keys shared with the another communication apparatus by one or more key sharing methods, and an application program configured to perform encrypted communication with the another communication apparatus using the shared key.

### TECHNICAL FIELD

The present disclosure relates to a communication system, a communication apparatus, a method, and a program.

### BACKGROUND ART

A key sharing protocol called quantum key distribution (QKD) is known (see, for example, Non Patent Literatures 1 and 2). QKD is a technique in which a key for concealing communication between two parties is shared by quantum teleportation, and data encrypted using the key is transmitted and received (encrypted communication).

In QKD, an entity that performs key sharing (key management entity (KME)) and an entity that performs data transmission and reception (secure application entity (SAE)) exist on different devices, and keys are shared and accumulated between KMEs using an optical communication network achieved by an optical fiber cable or the like. Then, when encrypted communication is performed between SAEs, the SAE on the transmission side acquires a key and a key ID from the KME corresponding thereto, and notifies the SAE on the reception side of the key ID. In the SAE on the reception side, the key identified by the key ID notified from the SAE on the transmission side is acquired from the KME corresponding to the SAE on the reception side. Thus, the same key is obtained between the SAE on the transmission side and the SAE on the reception side, and encrypted communication can be performed.

### CITATION LIST

### Non Patent Literature

### Non Patent Literature 1: ETSI GS QKD 004 V 2.1.1 (2020 August) Quantum Key Distribution (QKD); Application Interface

Non Patent Literature 2: ETSI GS QKD 014 V 1.1.1 (2019 February) Quantum Key Distribution (QKD); Protocol and data format of REST-based key delivery API

### SUMMARY OF INVENTION

### Technical Problem

In recent years, a method of generating a key (hereinafter referred to as a shared key) used for encrypting data transmitted and received between a transmission side and a reception side by combining keys of one or more key sharing methods including QKD and the like has been studied. However, the authentication-authorization method and the key identification method are different depending on the key sharing method, and thus it is considered that security is not sufficient only by simply combining keys of one or more key sharing methods.

The present disclosure has been made in view of the above points, and provides a technique capable of generating a shared key obtained by combining keys of one or more key sharing methods.

### Solution to Problem

A communication system according to one aspect of the present disclosure is a communication system including a plurality of communication apparatuses, in which the communication apparatuses each include a key generation unit configured to generate a shared key for performing encrypted communication with another communication apparatus of the plurality of communication apparatuses by using one or more keys shared with the another communication apparatus by one or more key sharing methods, and an application program configured to perform encrypted communication with the another communication apparatus using the shared key.

### Advantageous Effects of Invention

A technique capable of generating a shared key by combining keys of one or more key sharing methods is provided.

### BRIEF DESCRIPTION OF DRAWINGS

FIG. 1 is a diagram illustrating an example of an overall configuration of a communication system according to the present embodiment.

FIG. 2 is a diagram illustrating an example of a detailed functional configuration of a protocol conversion unit according to the present embodiment.

FIG. 3 is a sequence diagram illustrating an example of key sharing processing according to the present embodiment.

FIG. 4 is a sequence diagram illustrating an example of switching processing according to the present embodiment.

FIG. 5 is a diagram illustrating an example of a hardware configuration of a computer.

### DESCRIPTION OF EMBODIMENTS

Hereinafter, an embodiment of the present invention will be described. Hereinafter, a communication system 1 capable of generating a shared key by combining keys of one or more key sharing methods among a plurality of key sharing methods including QKD will be described. In addition, a case of switching the key sharing method to another key sharing method when a certain key sharing method becomes unable to be used for some reason at this time (for example, an error or the like) will also be described.

Here, examples of the key sharing method include a pre-shared key (PSK) method, a key exchange mechanism (KEM), and the like, in addition to QKD. KEM is, for example, a key sharing method using an encryption system such as RSA, elliptical encryption, or post quantum cryptography (PQC), and in particular, KEM using post quantum cryptography is a type of post-quantum cryptography-based key distribution (PQKD), and is also called PQC-KEM or the like. Hereinafter, it is assumed that QKD, PSK, and KEM (including PQC-KEM) are used as key sharing methods, and a shared key is generated by combining keys of one or more key sharing methods among these key sharing methods. Note that the key sharing method may be referred to as a key sharing protocol, a key exchange protocol, or the like, and refers to a technique for sharing the same key between the two.

With the communication system 1 described above, it is possible to generate a shared key obtained by combining keys of one or more key sharing methods, and encrypted communication can be performed between the application on the transmission side and the application on the reception side by the shared key. In addition, even if a certain key sharing method cannot be used for some reason (for example, an error or the like), it is possible to switch to another key sharing method, and thus it is possible to ensure continuity of a service that requires encrypted communication (in other words, availability of the service can be increased).

### Problems in Combining Keys of Plurality of Key Sharing Methods

In a case where keys of a plurality of key sharing methods are combined, authentication-authorization methods and key identification methods are different depending on the key sharing method, and thus it is considered that security is not sufficient only by simply combining keys of a plurality of key sharing methods.

For example, in the KEM, a specific authentication-authorization method is entrusted to an application, but authentication-authorization can be regarded as being integrated, and if mutual authentication is performed, authorization (access control) using a key can be treated as being performed at the same time. This is because the KEM generates a key by mutual operation between the transmission side and the reception side by an algorithm based on public key cryptography. On the other hand, in the QKD, a mechanism that gives the SAE access control (authorization) to the key corresponding to the key ID acquired from the KME is not specified, and even if mutual authentication is performed between the SAEs by some authentication method, it is unclear whether the authorization to the key corresponding to the key ID is correctly performed. In addition, in PSK, it can be considered that authentication-authorization are performed by setting a key by an administrator, a user, or the like. As described above, the authentication-authorization method may be different depending on the key sharing method.

Further, for example, in the KEM, a key is identified by session information such as a session ID. On the other hand, in QKD, a key is identified by a key ID. In PSK, generally, there is no information uniquely identifying a key, and a key is indirectly identified by, for example, some information or the like depending on a protocol used for communication with a communication partner. As described above, the key identification method is also different depending on the key sharing method.

Therefore, in the following embodiment, a method of generating a shared key by combining keys of one or more key sharing methods among a plurality of key sharing methods including QKD without depending on an authentication-authorization method or a key identification method will be described.

### Modeling of Key Sharing Method

In order to solve the above-described first problem that the authentication-authorization method may be different, key sharing methods other than QKD are modeled similarly to QKD. That is, in QKD, there are two entities a KME that is an entity (that is, an entity that executes processing logic for achieving key sharing at a time) that performs key sharing, and an SAE that is an entity that performs encrypted communication using a key shared between the KMEs. Accordingly, other key sharing methods other than QKD are also separated into two entities of KME and SAE, and modeling similar to QKD is performed.

For example, in PSK, a part that receives key setting from an administrator, a user, or the like can be modeled as KME, and a part (application) that performs encrypted communication using the key can be modeled as SAE. Similarly, for example, in the KEM, a portion that executes processing for sharing a key with a communication partner can be modeled as the KME, and a portion (application) that performs encrypted communication using the key can be modeled as the SAE.

Hereinafter, it is assumed that PSK and KEM are modeled in a model separated into SAE and KME described above.

### Overall Configuration Example of Communication System 1

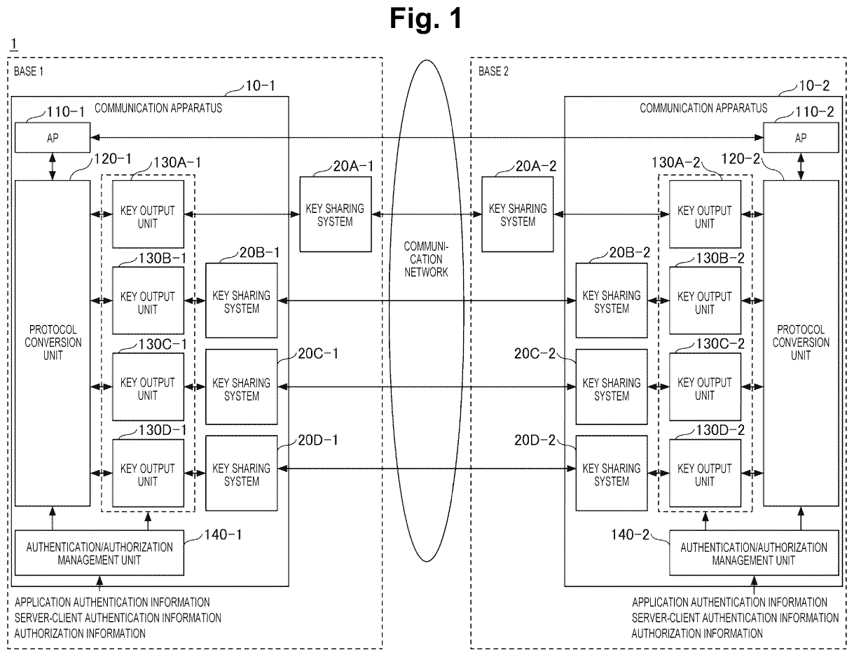

FIG. 1 illustrates an overall configuration of the communication system 1 according to the present embodiment. FIG. 1 illustrates, as an example, the communication system 1 in a case where encrypted communication is performed between a base 1 and a base 2. In the communication system 1 illustrated in FIG. 1, a case where the communication apparatus 10-1 is present in the base 1 and the communication apparatus 10-2 is present in the base 2 is illustrated. Further, in the communication system 1 illustrated in FIG. 1, a key sharing system 20A-1, a key sharing system 20B-1, a key sharing system 20C-1, and a key sharing system 20D-1 that function as a KME of a key sharing method usable by the communication apparatus 10-1, and correspond to each of these key sharing methods are also illustrated. Similarly, a key sharing system 20A-2, a key sharing system 20B-2, a key sharing system 20C-2, and a key sharing system 20D-2 that function as a KME of a key sharing methods usable by the communication apparatus 10-2, and correspond to each of these key sharing methods are also illustrated.

Here, it is assumed that the key sharing system 20A-1 and the key sharing system 20A-2 can share a key by a certain key sharing method (for example, QKD) in which the KME and the SAE exist on different devices. On the other hand, it is assumed that the key sharing system 20B-1 and the key sharing system 20B-2 can share a key by a certain key sharing method (for example, PSK and KEM) in which the KME and the SAE exist on the same device. Similarly, it is assumed that the key sharing system 20C-1 and the key sharing system 20C-2 or the key sharing system 20D-1 and the key sharing system 20D-2 can share a key by a certain key sharing method (for example, PSK and KEM) in which the KME and the SAE exist on the same device. Hereinafter, as an example, it is assumed that the key sharing system 20A-1 and the key sharing system 20A-2 correspond to OKD, the key sharing system 20B-1 and the key sharing system 20B-2 correspond to a certain KEM (hereinafter referred to as KEM-A), the key sharing system 20C-1 and the key sharing system 20C-2 correspond to another certain KEM (hereinafter, referred to as KEM-B), and the key sharing system 20D-1 and the key sharing system 20D-2 correspond to PSK.

Accordingly, in the example illustrated in FIG. 1, while the key sharing system 20A-1 exists separately from the communication apparatus 10-1, the key sharing system 20B-1, the key sharing system 20C-1, and the key sharing system 20D-1 are included in the communication apparatus 10-1. The same applies to the key sharing system 20A-2 to the key sharing system 20D-2.

Note that the communication apparatus 10-1 and the key sharing system 20A-1 are communicably connected by, for example, an in-base network or the like. Similarly, the communication apparatus 10-2 and the key sharing system 20A-2 are communicably connected by, for example, an in-base network or the like. On the other hand, the key sharing system 20B-1, the key sharing system 20C-1, and the key sharing system 20D-1 are achieved as functions provided by one or more programs installed in the communication apparatus 10-1. Similarly, the key sharing system 20B-2, the key sharing system 20C-2, and the key sharing system 20D-2 are achieved as functions provided by one or more programs installed in the communication apparatus 10-2.

Hereinafter, when the key sharing system 20A-1 to the key sharing system 20D-1 are not distinguished, they are referred to as a “key sharing system 20-1”. Similarly, when the key sharing system 20A-2 to the key sharing system 20D-2 are not distinguished, they are referred to as a “key sharing system 20-2”.

The communication apparatus 10-1 generates a shared key from one or more keys shared between the key sharing system 20-1 and the key sharing system 20-2 corresponding to one or more key sharing methods, and performs encrypted communication with the communication apparatus 10-2 using the shared key. Here, the communication apparatus 10-1 includes an application program (hereinafter referred to as AP) 110-1, a protocol conversion unit 120-1, a key output unit 130-1 corresponding to each key sharing system 20-1, and an authentication-authorization management unit 140-1. Note that, in the example illustrated in FIG. 1, the key output unit 130-1 corresponding to the key sharing system 20A-1 is a key output unit 130A-1. Similarly, the key output unit 130-1 corresponding to the key sharing system 20B-1 is the key output unit 130B-1, the key output unit 130-1 corresponding to the key sharing system 20C-1 is the key output unit 130C-1, and the key output unit 130-1 corresponding to the key sharing system 20D-1 is the key output unit 130D-1.

Similarly, the communication apparatus 10-2 generates a shared key from one or more keys shared between the key sharing system 20-2 and the key sharing system 20-1 corresponding to one or more key sharing methods, and performs encrypted communication with the communication apparatus 10-1 using the shared key. Here, the communication apparatus 10-2 includes an AP 110-2, a protocol conversion unit 120-2, a key output unit 130-2 corresponding to each key sharing system 20-2, and an authentication-authorization management unit 140-2. Note that, in the example illustrated in FIG. 1, the key output unit 130-2 corresponding to the key sharing system 20A-2 is a key output unit 130A-2. Similarly, the key output unit 130-2 corresponding to the key sharing system 20B-2 is the key output unit 130B-2, the key output unit 130-2 corresponding to the key sharing system 20C-2 is the key output unit 130C-2, and the key output unit 130-2 corresponding to the key sharing system 20D-2 is the key output unit 130D-2.

Hereinafter, when the communication apparatus 10-1 and the communication apparatus 10-2 are not distinguished from each other, they are referred to as a “communication apparatus 10”, and when the key sharing system 20-1 and the key sharing system 20-2 are not distinguished from each other, they are referred to as a “key sharing system 20”. The others are similarly expressed as an “AP 110”, a “protocol conversion unit 120”, a “key output unit 130”, and the like.

Further, when the key sharing system 20A-1 and the key sharing system 20A-2 are not distinguished from each other, they are denoted as a “key sharing system 20A”. The others are similarly referred to as a “key sharing system 20B”, a “key sharing system 20C”, a “key sharing system 20D”, and the like.

The AP 110 is an application program that performs encrypted communication with the AP 110 of another communication apparatus 10 using the shared key. That is, the AP 110 is an application program that functions as an SAE.

The protocol conversion unit 120 receives (a message indicating) a key request from the AP 110, generates (derives) a shared key by using one or more keys output from one or more key output units 130 and identification information thereof, and transmits (a message indicating) a key notification including the shared key to the AP 110. Further, when an error or the like occurs in the key sharing system 20, the protocol conversion unit 120 switches to another key sharing system 20. Note that a detailed functional configuration example of the protocol conversion unit 120 will be described later.

The key output unit 130 has a function of concealing a specific mechanism of the key sharing method executed by the key sharing system 20 corresponding to the key output unit 130, and returns a key shared by the key sharing system 20 corresponding to the key output unit 130 itself and its identification information when receiving a key request. That is, when receiving the key request from the protocol conversion unit 120, the key output unit 130 returns a key output including a key shared by the key sharing system 20 corresponding to the key output unit 130 and its identification information to the protocol conversion unit 120. Note that the key output unit 130 has a function of concealing a specific mechanism of the key sharing method, and thus may be referred to as, for example, a protocol driver or the like.

Thus, a specific mechanism of the key sharing method is concealed from the AP 110, and the AP 110 can obtain a shared key by simply making a key request to the protocol conversion unit 120 and by a key notification with respect to the key request.

Further, when an error or the like occurs in the key sharing system 20 corresponding to the key output unit 130, the key output unit 130 receives an error notification from the key sharing system 20 and transmits the error notification to the protocol conversion unit 120.

The authentication-authorization management unit 140 manages application authentication information, server-client authentication information, and authorization information. The application authentication information is information for authenticating the AP 110 in the host base, and is, for example, information (example: application ID, authentication information of AP 110) or the like indicating the AP 110 that permits the key request. The server-client authentication information is information for the key sharing system 20 in the host base to perform mutual authentication (that is, mutual authentication between KMEs) with the key sharing system 20 in the other base, and is, for example, a server certificate and a client certificate of the key sharing system 20 in the other base permitted as a connection destination. The authorization information is information for authorizing the key sharing system 20 in the host base to use the key of the AP 110 in the other base, and for example, information indicating the AP 110 in the other base that can be designated as a communication partner by the AP 110 in the host base, and information indicating the key sharing system 20 that can be used by the AP 110 in the other base. Note that the application authentication information, the server-client authentication information, and the authorization information are stored in the storage device.

The application authentication information enables the protocol conversion unit 120 to reject a key request from a source other than the predetermined AP 110. Further, the key sharing system 20 can perform mutual authentication with the key sharing system 20 in the other base by the server-client authentication information, and can reject key sharing with other than the key sharing system 20 that has been mutually authenticated. Furthermore, according to the authorization information, the key sharing system 20 can reject key sharing with other than the key sharing system 20 used by the predetermined AP 110 among the APs 110 in the other base, and as a result, it is possible not to authorize a key to an AP other than the predetermined AP 110.

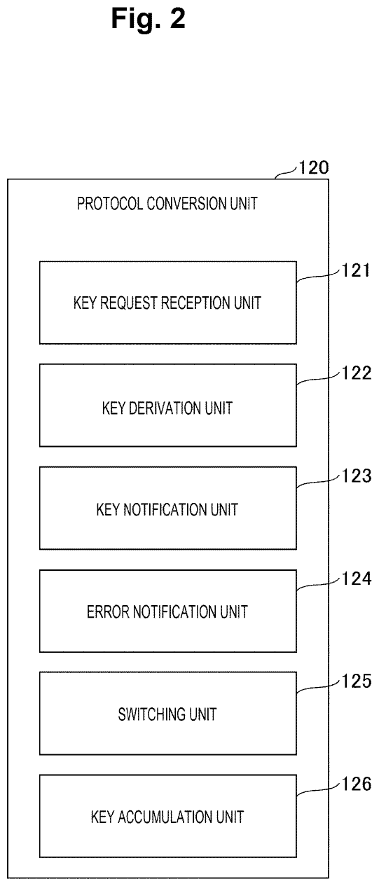

Here, a detailed functional configuration example of the protocol conversion unit 120 is illustrated in FIG. 2. As illustrated in FIG. 2, the protocol conversion unit 120 includes a key request reception unit 121, a key derivation unit 122, a key notification unit 123, an error notification unit 124, a switching unit 125, and a key accumulation unit 126.

The key request reception unit 121 receives a key request from the AP 110 and authenticates the AP 110 with reference to the application authentication information. Further, the key request reception unit 121 transmits the key request to the key output unit 130 corresponding to (the key sharing system 20 of) one or more key sharing methods currently used.

Further, the key request reception unit 121 receives the switching notification from the switching unit 125, and switches the key sharing method to be switched among the currently used key sharing methods to the key sharing method of the switching destination on the basis of the information included in the switching notification. Further, the key request reception unit 121 transmits the switching notification to the other communication apparatus 10.

The key derivation unit 122 receives a key output from each of the one or more key output units 130, and derives a shared key from a key included in each of the one or more key outputs, identification information thereof, and the like. Further, the key derivation unit 122 transmits a key output including the shared key to the key notification unit 123.

The key notification unit 123 receives the key output from the key derivation unit 122, extracts the shared key included in the key output, and then transmits a key notification including the shared key to the AP 110.

The error notification unit 124 receives an error notification from the key output unit 130 and transmits the error notification to the switching unit 125.

The switching unit 125 receives the error notification from the key output unit 130, determines a key sharing method of a switching destination of the key sharing method to be switched, and then transmits a switching notification including information indicating the key sharing method to be switched and the key sharing method of the switching destination to the key request reception unit 121.

When a key sharing method capable of accumulating keys is being used, the key accumulation unit 126 accumulates keys generated by the key sharing method in the storage device. Hereinafter, the keys accumulated in the storage device are also referred to as accumulated keys. The key accumulation unit 126 is not an essential component, and the protocol conversion unit 120 need not necessarily include the key accumulation unit 126.

Note that the overall configuration of the communication system 1 illustrated in FIG. 1 is an example, and the present invention is not limited thereto. For example, in the example illustrated in FIG. 1, it is assumed that the communication apparatus 10 can use four key sharing methods, and a key sharing system 20A to a key sharing system 20D corresponding to these key sharing methods are illustrated. However, in general, the key sharing system 20 exists as many as the number of key sharing methods that can be used by the communication apparatus 10. Specifically, for example, in a case where the communication apparatus 10 can use N key sharing methods, there are N key sharing systems 20 respectively corresponding to the N key sharing methods.

In addition, the communication network between the communication apparatuses 10 and the communication network between the key sharing system 20 may be the same, or may be different depending on the key sharing method executed by the key sharing system 20. For example, in a case where the key sharing method executed by a certain key sharing system 20 is QKD, the communication network between (the APs 110 of) the communication apparatuses 10 is the Internet or the like, and the communication network between the key sharing systems 20 is an optical communication network or the like. On the other hand, for example, when the key sharing method executed by a certain key sharing system 20 is KEM or the like, the communication network between (the AP 110 of) the communication apparatuses 10 and the communication network between the key sharing system 20 are both the Internet or the like.

### Key Sharing Processing

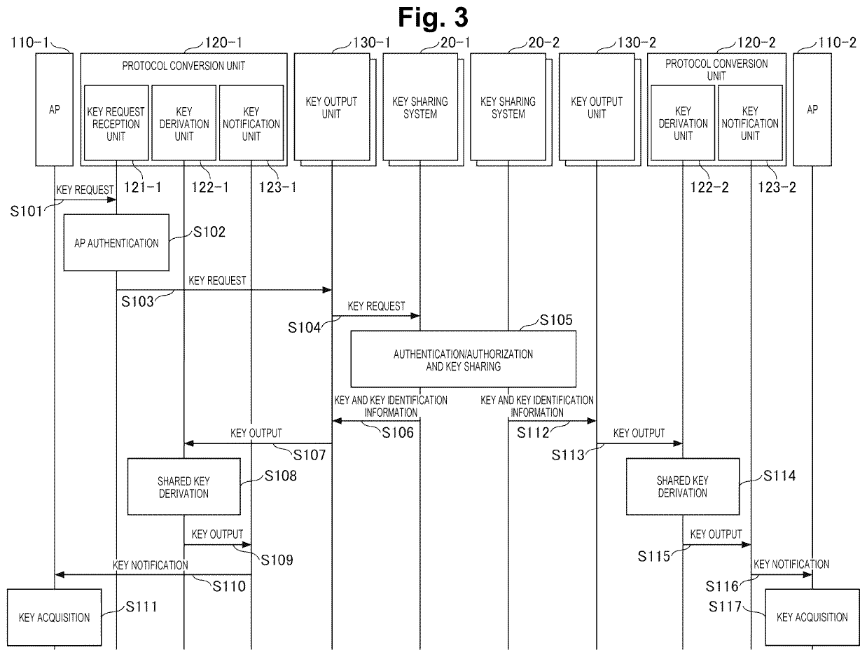

Hereinafter, as an example, assuming that the AP 110-1 performs encrypted communication with the AP 110-2, a key sharing process for sharing a shared key between the AP 110-1 and the AP 110-2 will be described with reference to FIG. 3. Note that the AP 110-1 corresponds to an initiator, and the AP 110-2 corresponds to a responder.

First, the AP 110-1 transmits a key request to the protocol conversion unit 120-1 (step S101).

Upon receiving the key request, the key request reception unit 121-1 of the protocol conversion unit 120-1 authenticates the AP 110-1 that is the transmission source of the key request with reference to the application authentication information (step S102). For example, the key request reception unit 121-1 determines that the authentication succeeds when the application ID (alternatively, the authentication information) of the AP 110-1 that is the transmission source of the key request is included in the application authentication information, and determines that the authentication fails otherwise. When the authentication of the AP 110-1 is successful, the processing of step S102 is executed, and when the authentication is unsuccessful, the processing of step S102 and subsequent steps is not executed. In the following description, it is assumed that the authentication of the AP 110-1 is successful.

The key request reception unit 121-1 of the protocol conversion unit 120-1 transmits the key request to one or more key output units 130 corresponding to one or more key sharing methods set as the currently used key sharing method (step S103). For example, in a case where three key sharing methods “QKD”, “KEM-A”, and “KEM-B” are set as the key sharing methods currently used, the key request reception unit 121-1 transmits the key request to the key output unit 130A-1 corresponding to the key sharing system 20A-1 that performs key sharing by QKD, the key output unit 130B-1 corresponding to the key sharing system 20B-1 that performs key sharing by KEM-A, and the key output unit 130C-1 corresponding to the key sharing system 20C-1 that performs key sharing by KEM-B.

Upon receiving the key request from the key request reception unit 121-1, each key output unit 130-1 transmits the key request to the key sharing system 20-1 corresponding thereto (step S104). For example, when the key output unit 130A-1 receives a key request, the key output unit 130A-1 transmits the key request to the key sharing system 20A-1. Similarly, for example, when the key output unit 130B-1 receives a key request, the key output unit 130B-1 transmits the key request to the key sharing system 20B-1. Similarly, for example, when the key output unit 130C-1 receives a key request, the key output unit 130C-1 transmits the key request to the key sharing system 20C-1.

When receiving a key request from the key output unit 130-1 corresponding to each key sharing system 20-1, the each key sharing system 20-1 performs authentication-authorization with the key sharing system 20-2 corresponding to the same key sharing method as the each key sharing system 20-1, and shares a key by the key sharing method (step S105). At this time, the key sharing system 20-1 and the key sharing system 20-2 perform mutual authentication using the server certificate and the client certificate included in the server-client authentication information. Further, the key sharing system 20-1 refers to the authorization information and determines whether or not to give authorization regarding use of a key shared with the key sharing system 20-2 to the AP 110-2. For example, in a case where the information indicating the key sharing system 20-2 is included in the authorization information as information indicating the available key sharing system 20 of the AP 110-2 that can be designated as the communication partner by the AP 110-1 that is the transmission source of the key request, the key sharing system 20-1 determines to authorize the use of the key to the AP 110-2, and determines not to authorize the use of the key otherwise. Note that, although the case where only the authorization information is referred to when the key sharing system 20-1 determines whether or not to authorize the use of the key has been described, the application authentication information may be referred to in addition to the authorization information in order to authenticate the AP 110-1 that is the transmission source of the key request again.

Here, when key sharing is performed between the key sharing system 20-1 and the key sharing system 20-2 in step S105 described above, key distribution and key generation are performed in addition to the mutual authentication-authorization described above in the case of QKD and KEM. On the other hand, in the case of PSK, key distribution and key generation are not performed, and only the above mutual authentication-authorization are performed.

Note that, in step S105 described above, a server certificate and a client certificate are used as mutual authentication between the key sharing systems 20, but this is merely an example, and the present invention is not limited thereto. Any authentication method can be used for mutual authentication between the key sharing systems 20 in step S105.

Each key sharing system 20-1 transmits the key shared with the key sharing system 20-2 corresponding to the same key sharing method as that of the each key sharing system 20-1 in step S105 and its identification information (hereinafter referred to as key identification information) to the key output unit 130-1 corresponding to the each key sharing system 20-1 (step S106). Here, the key identification information is information for identifying a key shared with the key sharing system 20-2, and is, for example, session information such as a key ID (alternatively, in the case of QKD not using REST, it may be a session ID) in the case of QKD and a session ID or the like in the case of KEM. In the case of PSK, some information or the like depending on the protocol used for communication with a communication partner is used, but since a session is identified by these pieces of information in general, these pieces of information are also referred to as session information below.

Upon receiving the key and the key identification information from the key sharing system 20-1 corresponding to each key output unit 130-1, the each key output unit 130-1 transmits a key output including the key and the key identification information to the protocol conversion unit 120-1 (step S107).

Upon receiving the key output from each key output unit 130-1, the key derivation unit 122-1 of the protocol conversion unit 120-1 derives the shared key from the key, the key identification information, and the like included in each of the key outputs (step S108). For example, the key derivation unit 122-1 derives a shared key SK by SK=KDF (secretKey, label, context, key_length). Here, the KDF is a predetermined key derivation function. The secretKey is information obtained by concatenating keys of one or more key sharing methods set as the key sharing method currently used. The label is information obtained by concatenating labels (for example, a character string indicating the name of the key sharing method or the like) representing one or more key sharing methods set as the key sharing method currently used. The context is information (alternatively, for example, in a case where the input length of the KDF is limited, the hash value may be used) obtained by concatenating key identification information of each key of one or more key sharing methods set as the key sharing method currently used. The key_length is a predetermined key length. However, the key identification information of each key of one or more key sharing methods used for the context is generated so as to be unique every time the key is generated in each key sharing method. If this cannot be ensured, a different value is shared every time when key sharing is performed between the base 1 and the base 2, and information indicating the value is used for the context. Thus, it is possible to ensure that the key derived by the key derivation unit 122 is different for each key sharing request.

### Specific Example 1

It is assumed that three key sharing methods “QKD”, “KEM-A”, and “KEM-B” are set as the key sharing method currently used. Further, it is assumed that the key of QKD is “sk”, its key identification information is “skID”, the key of KEM-A is “SK1”, its key identification information is “S11”, the key of KEM-B is “SK2”, and its key identification information is “S12”. Further, it is assumed that the QKD label is “QKD”, the KEM-A label is “KEM-A”, and the KEM-B label is “KEM-B”.

In this case, secretKey=sk∥SK1∥SK2, context=skID∥S11∥S12, label=QKD∥KEM-A∥KEM-B. Here, ∥ indicates a concatenation of information (for example, a concatenation of bit strings indicating the information).

Therefore, SK=KDF (sk∥SK1∥SK2, QKD∥KEM-A∥KEM-B, skID∥S11∥S12, key_length) holds.

### Specific Example 2

It is assumed that three key sharing methods “PSK”, “KEM-A”, and “KEM-B” are set as the key sharing method currently used. Further, it is assumed that the key of PSK is “psk”, its key identification information is “pskSession”, the key of KEM-A is “SK1”, its key identification information is “S11”, the key of KEM-B is “SK2”, and its key identification information is “S12”. Further, it is assumed that the PSK label is “PSK”, the KEM-A label is “KEM-A”, and the KEM-B label is “KEM-B”.

In this case, secretKey=psk∥SK1∥SK2, context=pskSession∥S11∥S12, label=PSK∥KEM-A∥KEM-B holds.

Therefore, SK=KDF (psk∥SK1∥SK2, pskSession∥KEM-A∥KEM-B, pskSession∥S11∥S12, key_length) holds.

Note that, although QKD is included in the label in above-described Specific Example 1 and PSK is included in the label in above-described Specific Example 2, the label may be included only in a case where a plurality of key sharing methods of the same type is used among the key sharing methods currently used. For example, in above-described Specific Example 1, label=KEM-A∥KEM-B may be set. Similarly, for example, label=KEM-A∥KEM-B may also be set in above-described Specific Example 2.

The key derivation unit 122-1 of the protocol conversion unit 120-1 transmits the key output including the shared key SK derived in step S108 to the key notification unit 123-1 (step S109).

Upon receiving the key output from the key derivation unit 122-1, the key notification unit 123-1 of the protocol conversion unit 120-1 extracts the shared key SK included in the key output and then transmits a key notification including the shared key SK to the AP 110-1 (step S110).

Upon receiving the key notification from the protocol conversion unit 120-1, the AP 110-1 acquires the shared key SK included in the key notification (step S111).

On the other hand, each of the key sharing systems 20-2 transmits the key shared with the key sharing system 20-1 corresponding to the same key sharing method as that of the key sharing system 20-2 in step S105 and its key identification information to the key output unit 130-2 corresponding to the key sharing system 20-2 (step S112).

Upon receiving the key and the key identification information from the key sharing system 20-2 corresponding to each key output unit 130-2, the each key output unit 130-2 transmits a key output including the key and the key identification information to the protocol conversion unit 120-2 (step S113).

Upon receiving the key output from each key output unit 130-2, the key derivation unit 122-2 of the protocol conversion unit 120-2 derives the shared key from the key, the key identification information, and the like included in each of the key outputs (step S114). Note that the key derivation unit 122-2 derives the shared key SK by a method similar to that in step S108 described above.

The key derivation unit 122-2 of the protocol conversion unit 120-2 transmits the key output including the shared key SK derived in step S114 to the key notification unit 123-2 (step S115).

Upon receiving the key output from the key derivation unit 122-2, the key notification unit 123-2 of the protocol conversion unit 120-2 extracts the shared key SK included in the key output and then transmits a key notification including the shared key SK to the AP 110-2 (step S116).

Upon receiving the key notification from the protocol conversion unit 120-2, the AP 110-2 acquires the shared key SK included in the key notification (step S117).

As described above, since the same shared key SK is shared between the AP 110-1 and the AP 110-2, encrypted communication can be performed using the shared key SK as an encryption key.

Note that when the key is shared in step S105 described above, it is not limited to a case where a new key is generated between the key sharing systems 20, and for example, in a case where the key accumulation unit 126 accumulates a key (accumulated key), the accumulated key may be shared. In particular, for example, the accumulated key may be shared in a case where a new key cannot be generated for some reason such as occurrence of an error. In this case, for example, the key output unit 130 only needs to transmit an acquisition request for an accumulated key to the key accumulation unit 126 in response to a request from the key sharing system 20. Thus, since the accumulated key is returned from the key accumulation unit 126 to the key output unit 130, the key output unit 130 only needs to transmit the key output including the accumulated key to the key derivation unit 122.

### Switching Processing

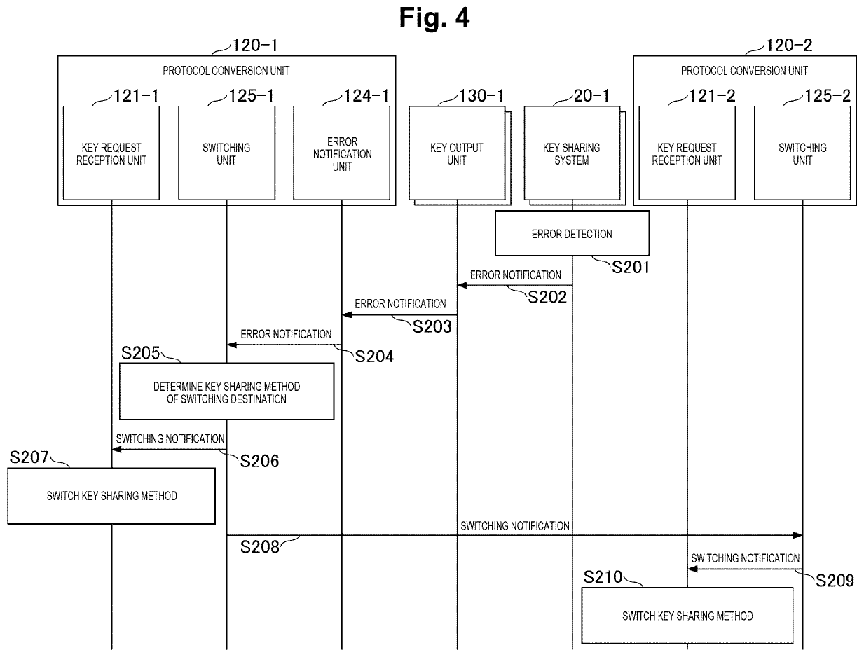

Hereinafter, as an example, switching processing in a case where some error occurs in the key sharing system 20-1 corresponding to a certain key sharing method among one or more key sharing methods set as the currently used key sharing method and the key sharing method is switched to another key sharing method will be described with reference to FIG. 4.

The key sharing system 20-1 detects the occurrence of an error (step S201). Here, various errors are conceivable as errors occurring in the key sharing system 20-1 and the present embodiment can target any error, but for example, the following errors can be targeted. Note that the error may be, for example, what is called a failure, an abnormality, or the like.
(1) Key request error (for example, a communication error when key sharing with the key sharing system 20-2 is performed, an internal error of the key sharing system 20-1 when key sharing is performed, and the like)
(2) Key exhaustion (exhaustion of keys accumulated by the key accumulation unit 126 is also included)
(3) Computing capacity exhaustion
(4) System error
(5) Tamper abnormality

Note that, for example, an event in which key sharing becomes impossible due to tapping on an optical fiber cable used by the key sharing system 20-1 corresponding to QKD may occur, and such an event may be detected as the tamper abnormality.

The key sharing system 20-1 transmits an error notification related to the error detected in the above step S201 to the key output unit 130-1 corresponding thereto (step S202). Note that the error notification includes, for example, information indicating the key sharing system 20 in which the error has been detected, the content of the error, the cause of the error, and the like.

Upon receiving the error notification from the key sharing system 20-1, the key output unit 130-1 transmits the error notification to the protocol conversion unit 120-1 (step S203).

Upon receiving the error notification from the key output unit 130-1, the error notification unit 124-1 of the protocol conversion unit 120-1 transmits the error notification to the switching unit 125-1 (step S204).

Upon receiving the error notification from the error notification unit 124-1, the switching unit 125-1 of the protocol conversion unit 120-1 determines a key sharing method to be a switching destination of the key sharing method corresponding to the key sharing system 20-1 in which the error has been detected (step S205). Here, the switching unit 125 can determine the key sharing method to be the switching destination by various methods, and for example, it is conceivable to determine the key sharing method to be the switching destination by the following method.
(a) The key sharing method to be the switching destination is determined according to the error content or the error cause included in the error notification. This is, for example, a method in which an error content or an error cause is associated with a key sharing method to be a switching destination in advance for each key sharing method, and the key sharing method to be the switching destination is determined based on the correspondence.
(b) One key sharing method is determined as a switching destination randomly or in a predetermined order (predetermined priority order) from among key sharing methods other than the key sharing method to be switched.
(c) An error content or an error cause included in the error notification is notified to the AP 110 or the user, and a key sharing method to be a switching destination is determined according to an instruction from the AP 110 or an instruction from the user. In this case, since the AP 110 or the user can confirm the error content or the error cause, an appropriate key sharing method can be determined as the switching destination according to the error content or the error cause.

Note that any of the above determination methods is an example, and the key sharing method to be the switching destination may be determined by other various methods. In addition, for example, in a case where the key accumulation unit 126 accumulates a key, it may be determined to switch the acquisition destination of the key of the key sharing method corresponding to the key sharing system 20 in which the error is detected to the accumulated key. Thus, the accumulated key is used until the accumulated key is exhausted, and the key sharing method can be switched after the accumulated key is exhausted. In the following description, it is assumed that a key sharing method to be a switching destination is determined.

The switching unit 125-1 of the protocol conversion unit 120-1 sets the key sharing method corresponding to the key sharing system 20-1 in which the error is detected as the key sharing method to be switched, and sets the key sharing method determined in the above step S205 as the key sharing method of a switching destination, and transmits switching notification including information indicating the key sharing method to be switched and information indicating the key sharing method of a switching destination to the key request reception unit 121-1 (step S206).

Upon receiving the switching notification from the switching unit 125-1, the key request reception unit 121-1 of the protocol conversion unit 120-1 switches the key sharing method to be switched among the one or more key sharing methods set as the key sharing method currently used to the key sharing method of the switching destination on the basis of the information indicating the key sharing method to be switched and the information indicating the key sharing method of the switching destination included in the switching notification (step S207).

Further, the switching unit 125-1 of the protocol conversion unit 120-1 transmits the switching notification to the protocol conversion unit 120-2 (step S208).

Upon receiving the switching notification from the protocol conversion unit 120-2, the switching unit 125-2 of the protocol conversion unit 120-2 transmits the switching notification to the key request reception unit 121-2 (step S209).

Upon receiving the switching notification from the switching unit 125-2, the key request reception unit 121-2 of the protocol conversion unit 120-2 switches the key sharing method to be switched among the one or more key sharing methods set as the key sharing method currently used to the key sharing method of the switching destination on the basis of the information indicating the key sharing method to be switched and the information indicating the key sharing method of the switching destination included in the switching notification (step S210).

As described above, when an error or the like occurs in a certain key sharing system 20 and the key sharing system 20 becomes unable to be share the key, it is possible to switch to generate the key in another key sharing system 20. In addition, in a case where the accumulated key exists, it is also possible to switch to use the accumulated key. Therefore, even in a case where the key sharing system 20 cannot be used, it is possible to continuously derive the shared key necessary for encrypted communication, and it is possible to continue the service provided by the AP 110.

### Hardware Configuration Example

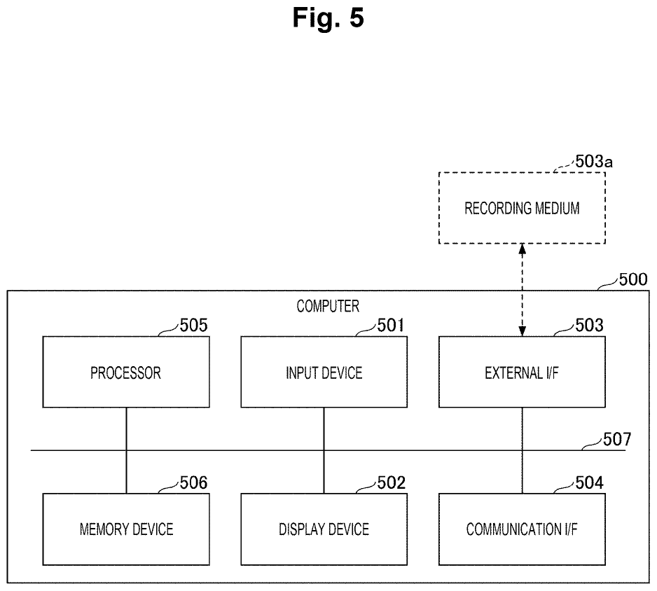

The communication apparatus 10 included in the communication system 1 according to the present embodiment and the key sharing system 20 corresponding to QKD can be achieved by, for example, a hardware configuration of a computer 500 illustrated in FIG. 5. The computer 500 illustrated in FIG. 5 includes an input device 501, a display device 502, an external I/F 503, a communication I/F 504, a processor 505, and a memory device 506. Each of these pieces of hardware is communicably connected via a bus 507.

The input device 501 is, for example, a keyboard, a mouse, a touch panel, a physical button of various types, or the like. The display device 502 is, for example, a display, a display panel, or the like. The computer 500 need not necessarily include, for example, either the input device 501 or the display device 502.

The external I/F 503 is an interface with an external device such as a recording medium 503a. Examples of the recording medium 503a include a CD-ROM, a DVD-ROM, an SD memory card, a USB memory card, and the like.

The communication I/F 504 is an interface for connecting the computer 500 to a communication network. The processor 505 is, for example, any of various arithmetic devices such as a central processing unit (CPU). The memory device 506 is, for example, any of various storage devices such as a hard disk drive (HDD), a solid state drive (SSD), a random access memory (RAM), a read only memory (ROM), or a flash memory.

However, the hardware configuration of the computer 500 illustrated in FIG. 5 is an example, and the hardware configuration is not limited thereto. For example, the computer 500 may include a plurality of processors 505 and a plurality of memory devices 506, may not include a part of the illustrated hardware, or may include various hardware other than the illustrated hardware.

Note that one or more programs for implementing the key sharing system 20 corresponding to the key sharing method (for example, PSK, KEM, or the like) in which the SAE and the KME are present on the same device when performing modeling similar to that of the AP 110, the protocol conversion unit 120, the key output unit 130, and QKD illustrated in FIG. 1 are stored in the memory device 506, and various functions are implemented by the processor 505 executing various processes by the one or more programs.

### CONCLUSION

As described above, in the communication system 1 according to the present embodiment, encrypted communication can be performed between the APs 110 (application programs) using a shared key obtained by combining keys of one or more key sharing methods. Moreover, even in a case where the authentication-authorization method and the key identification method are different depending on each key sharing method, it is possible to perform unified authentication-authorization and key identification, and it is possible to generate a shared key combining keys of a plurality of key sharing methods without compromising security.

In addition to the above, in the communication system 1 according to the present embodiment, when a certain key sharing method cannot be used for some reason, it is possible to switch to another key sharing method. Therefore, the availability of the service provided by the application program using the encrypted communication can be enhanced, and the service quality can be improved.

The present invention is not limited to the above specifically disclosed embodiment, and various modifications and changes, combinations with known techniques, and the like can be made without departing from the scope of the claims.

### REFERENCE SIGNS LIST

1 Communication system
10 Communication apparatus
20 Key sharing system
110 AP
120 Protocol conversion unit
121 Key request reception unit
122 Key derivation unit
123 Key notification unit
124 Error notification unit
125 Switching unit
126 Key accumulation unit
130 Key output unit
140 Authentication-authorization management unit
500 Computer
501 Input device
502 Display device
503 External I/F
503a Recording medium
504 Communication I/F
505 Processor
506 Memory device
507 Bus

1. A communication system comprising a plurality of communication apparatuses, wherein
the communication apparatuses each include
a first memory; and
a first processor coupled to the first memory and configured to:
generate a shared key for performing encrypted communication with another communication apparatus of the plurality of communication apparatuses by using one or more keys shared with the another communication apparatus by one or more key sharing methods, and
perform encrypted communication with the another communication apparatus using the shared key.

2. The communication system according to claim 1, wherein
the first processor is configured to
generate the shared key with a predetermined key derivation function using the one or more keys and one or more pieces of key identification information identifying each of the one or more keys.

3. The communication system according to claim 2, wherein
the first processor is configured to
generate, in a case where a plurality of key sharing methods of a same type is included in the one or more key sharing methods, the shared key by further using a label representing each of the plurality of key sharing methods of the same type.

4. The communication system according to claim 1, wherein:
the first processor is further configured to perform, when receiving a request for the shared key from the application program, authentication processing of the application program with reference to preset application authentication information,
the communication system further comprises a key sharing system configured to share a key with another key sharing system by the key sharing method, and
the key sharing system is configured to
perform mutual authentication processing with the another shared system and perform authorization processing of a key to be shared with the another key sharing system using preset authorization information.

5. The communication system according to claim 4, comprising:
a second memory; and
a second processor coupled to the second memory and configured to:
switch a key sharing method that becomes unable to share a key between the key sharing system and the another key sharing system among the one or more key sharing methods to another key sharing method.

6. A communication apparatus comprising:
a first memory; and
a first processor coupled to the first memory and configured to:
generate a shared key for performing encrypted communication with another communication apparatus by using one or more keys shared with the another communication apparatus by one or more key sharing methods; and
perform encrypted communication with the another communication apparatus using the shared key.

7. A method used in a communication system including a plurality of communication apparatuses, the method comprising:
generating, by a communication apparatus of the plurality of communication apparatuses, a shared key for performing encrypted communication with another communication apparatus of the plurality of communication apparatuses by using one or more keys shared with the another communication apparatus by one or more key sharing methods, and
performing, by the communication apparatus, encrypted communication with the another communication apparatus using the shared key.

8. A non-transitory computer-readable recording medium storing a program for causing a computer to perform the method of claim 7.
